(19) United States
(12) Patent Application Publication
(10) Pub. No.: US 2018/0100631 A1
(43) Pub. Date: Apr. 12, 2018

(54) A LOW ENERGY BUILDING

(71) Applicant: X TEC PTY LTD, Coomera, QLD (AU)

(72) Inventors: Brian MACDONALD, Coomera (AU); Chris O'NEILL, Coomera (AU); Dallyn SEALE, Coomera (AU); Mark CLARK, Coomera (AU)

(21) Appl. No.: 15/573,413

(22) PCT Filed: May 11, 2016
(86) PCT No.: PCT/AU2016/050352

§ 371 Date: Nov. 10, 2017

(30) Foreign Application Priority Data
May 11, 2015 (AU) 2015901701
May 29, 2015 (AU) 2015902008
Jun. 12, 2015 (AU) 2015902217
Jul. 28, 2015 (AU) 2015902995
Dec. 3, 2015 (AU) 2015905009
Mar. 15, 2016 (AU) 2016900966

(51) Int. Cl. F21V 3/04; F21S 9/03; H05B 37/02; F21K 9/64; F21K 9/275; F21V 23/04

(52) U.S. Cl. CPC F21V 3/0463; F21S 9/032; H05B 37/0281; F21Y 2115/10; F21K 9/275; F21V 23/0471; F21K 9/64

(57) ABSTRACT

The present invention relates to a building. The building includes a distributed power supply and a lighting system for being powered by the distributed power supply. The system includes distributed lights for being coupled to the distributed power supply. Covers are provided for covering respective lights. Photoluminescence is borne by each cover. Advantageously, the light charges the photoluminescence borne by the cover. In turn, the cover passively discharges and provides passive illumination in the dark by virtue of the photoluminescence. The building lighting system provides illumination for after-hours personnel in the building after the light is turned off, or in the event of a power disruption when a backup power generator is not present.

### TECHNICAL FIELD

The present invention generally relates to a low energy building within a low-energy building lighting system. The present invention has particular application to commercial buildings such as factories and office buildings having large numbers of distributed lights.

### BACKGROUND

The reference to any prior art in this specification is not, and should not be taken as an acknowledgement or any form of suggestion that the prior art forms part of the common general knowledge.

A fluorescent tube is a low pressure mercury-vapor gas-discharge lamp that uses fluorescence to produce visible light.

Commercial buildings such as factories and office buildings are typically filled with powered fluorescent tubes which consume power. These buildings often remain at least in part illuminated after hours for security, or to assist after-hours personnel such as cleaners and guards in their duties. In the event of a power disruption, backup power generators often ensure that the building remains illuminated.

Undesirably, the distributed (e.g. 110V, 240V etc.) power consumption of commercial buildings is high. In practice, the lights are often needlessly left activated after hours which is not only an unnecessary expense, but also harmful to the environment. Earth Hour is a worldwide movement for the planet encouraging building owners to turn off their non-essential lights for one hour, from 8:30 to 9:30 p.m. on the last Saturday in March, as a symbol of their commitment to the environment. Whilst one hour a year is a start, more can be done.

The Applicant has perceived a need for an alternative low energy building for after-hours illumination.

### SUMMARY OF THE INVENTION

According to one aspect of the present invention, there is provided a building including:

a distributed power supply; and

a lighting system for being powered by the distributed power supply, the system including:
distributed lights for being coupled to the distributed power supply;
covers for covering respective lights; and
photoluminescence borne by each cover.

Advantageously, the light charges the photoluminescence borne by the cover. In turn, the cover passively discharges and provides passive illumination in the dark by virtue of the photoluminescence. The building lighting system provides illumination for after-hours personnel in the building after the light is turned off, or in the event of a power disruption when a backup power generator is not present. The photoluminescence may be within the cover.

The distributed power supply may include a mains power supply (e.g. 240V), a battery and/or solar cells.

The building may include an actuator configured to cycle actuation of the lights whereby some of the lights are actuated at one time and other lights are not concurrently actuated, but the lights are all eventually actuated.

The lights may be arranged in zones within the building. The building may include an actuator for actuating the lights in the zones at intervals. In one embodiment, during actuation of the zones, some of the zones are actuated at one time and other zones are not concurrently actuated, but the zones are all eventually actuated. In an alternative embodiment, during concurrent actuation of each zone, some of the lights are actuated at one time and other lights are not concurrently actuated, but the lights are all eventually actuated. Each zone may relate to a respective floor. Each zone may relate to a respective room or corridor.

The building may include a motion sensor for sensing motion a zone, and an actuator for actuating lights in the zone responsive to sensed motion.

The lights may be arranged in banks, whereby some of the banks are actuated at one time and other banks are not concurrently actuated, but the banks are all eventually actuated.

The building may be a commercial building. The building may by a factory. The building may be an office building.

According to another aspect of the present invention, there is provided a building lighting system including:

a light for coupling to a distributed power supply;

a cover for covering the light; and

photoluminescence borne by the cover.

The system may further include the distributed power supply for powering the light. The power supply many include an actuator for actuating the light at intervals. The actuator may include a timer. The timer may be variable. The intervals may be regular intervals (e.g. hourly). The duty cycle of the power supply may be less than 10% (i.e. on for less than 6 minutes in the hour).

The light may include a fluorescent tube. The light may include one or more light emitting diodes (LEDs). The system may be shaped like a fluorescent tube and hold the LEDs. In one embodiment, the LEDs include a strip of LEDs. In another embodiment, the LEDs are included in a panel. The panel may be planar.

The light may emit higher intensity white light. The light may emit lower intensity ultra-violet light. The light may emit higher intensity and lower intensity light. The higher intensity and lower intensity light may be emitted from respective light sources.

The cover may include a diffuser. The cover may include a tube. The tube may be dimensioned to receive a fluorescent tube. The cover may include a panel. The panel may be planar.

The light may include a base including a light source. The base may include a thread or bayonet fitting. The cover may include a cap for capping the base. The cap may be flat, dome shaped or arced.

The system may further include a connector for connecting the cover and light together. The connector may include a frame for bordering the light. The lighting system may be portable. The cover may be translucent.

Preferably, the photoluminescence is not a coating but is dispersed throughout the cover. The photoluminescence may be mixed throughout the cover. The cover may include an overall photoluminescence between 0.25% and 35%.

The photoluminescence may take the form of a photoluminescent luminous pigment “master batch”, which may contain between 5% and 65% photoluminescent compound. The master batch may be incorporated within a plastic carrier which matches the intended base material forming the cover.

The cover may include polymeric material. The cover may include polyethylene (PE), polypropylene (PP), polyamide (PA), polyethylene terephthalate (PET), polyvinyl chloride (PVC), polymethyl methacrylate (PMMA), or other like hard polymeric material. The cover may be molded. The cover may be injection molded.

According to another aspect of the present invention, there is provided a building light cover for covering a light to be coupled to a distributed power supply, and including photoluminescence.

According to another aspect of the present invention, there is provided a method for manufacturing a building light cover for covering a light to be powered by a distributed power supply, the method including:

adding photoluminescence within a polymer.

The step of adding may involve dispersing the photoliminescence throughout the polymer. The dispersing may involve mixing the photoliminescence throughout the polymer. The mixing may occur prior to forming (e.g. extruding, molding, etc.) of the cover. Alternatively, the adding may occur during forming of the cover.

The method may include the step of heating the polymer and/or photoluminescence. The cover may be injection molded with the polymer and/or photoluminescence heated to between 200 to 250° C. The cover may be extruded with the polymer and/or photoluminescence heated to between 190 to 220° C.

The method may involve cooling the polymer and/or photoluminescence. The cooling may be controlled.

The present specification also discloses a building lighting system including:

an ultra-violet (UV) light for coupling to a distributed power supply; and an emitter including photoluminescence and for being charged by the light.

According to another aspect of the present invention, there is provided a building lighting system including:

a light for coupling to a distributed power supply and able to emit higher intensity light and lower intensity light; and

an emitter including photoluminescence and for being charged by the light.

According to another aspect of the present invention, there is provided a light arrangement including:
a light including at least one white light emitting diode (LED) and at least one ultra-violet (UV) LED; and
a cover including photoluminescence and for covering the light.

Advantageously, the LEDs draw low power. The white LED may be ordinarily continuously operated to charge photoluminescence. The white LED may be turned off after hours. The photoluminescence then passively discharges in the dark and provides passive illumination for after-hours personnel. The UV LED may be activated to recharge the photoluminescence with less annoyance to the after-hours personnel than otherwise actuating the white LED.

The light arrangement may include a battery for powering the UV LED. The battery may be rechargeable. The battery may be a long life Lithium Iron Phosphate (LiFePO4) battery. The light arrangement may include a recharger for recharging the battery. The recharger may be powered from mains or solar power.

The light arrangement may include an actuator for actuating the LEDs. The light arrangement may include a motion sensor for sensing motion, and the actuator may actuate one or both of the LEDs responsive to sensed motion. The actuator may include a timer. The timer may be programmable and variable to alter the duty cycle (e.g. 5 seconds on, 5 minutes off) of the UV LED to control the passive brightness of the photoluminescence.

The LEDs may be in strips extending along the cover. Alternatively or additionally, the LEDs may be mounted at one or both ends of the light. The light arrangement may include at least one reflector for reflecting light within the cover. The reflector may be located in the centre of the cover. The light arrangement may include at least one lens for focusing light in the cover.

The UV LED may have a wavelength of about 365 nm to maximally charge the photoluminescence. The cover may include a thermoplastic such as polypropylene or Polymethyl methacrylate (PMMA). The photoluminescence may be dispersed throughout the cover. The light arrangement may be a replacement for retrofitting in place of a conventional fluorescent tube. The replacement may be powered from a single end.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1a is a side schematic view of a low energy office building in accordance with an embodiment of the present invention;

FIG. 1b is a plan view of a floor of the office building of FIG. 1a, showing lighting zones;

FIG. 2 is a perspective sectional view of a factory building in accordance with another embodiment;

FIG. 3 is a perspective view of a building lighting system in accordance with an embodiment of the present invention;

FIG. 4a is a block diagram of the lighting system of FIG. 1;

FIG. 4b is a schematic diagram showing the cycled actuation of banks of lights;

FIG. 5 is a perspective view of an unassembled building lighting system in accordance with another embodiment of the present invention;

FIG. 6 is a perspective view of an unassembled building lighting system in accordance with another embodiment of the present invention;

FIG. 7 is a further perspective view of the assembled building lighting system of FIG. 6;

FIG. 8 is a perspective view of a building lighting system in accordance with another embodiment of the present invention;

FIG. 9a is a perspective view of a domestic light fitting in accordance with an embodiment of the present invention;

FIG. 9b is a perspective view of a domestic light fitting in accordance with another embodiment of the present invention;

FIG. 9c is a perspective view of a domestic light fitting in accordance with another embodiment of the present invention;

FIG. 10 is a perspective view of a building lighting system in accordance with another embodiment of the present invention;

FIG. 11 is a block diagram showing a light replacement including the lighting system of FIG. 10;

FIG. 12 is a schematic diagram of the light replacement shown in FIG. 11; and

FIG. 13 shows front views of various endcaps of the light replacement of FIG. 12.

### DETAILED DESCRIPTION OF PREFERRED EMBODIMENTS

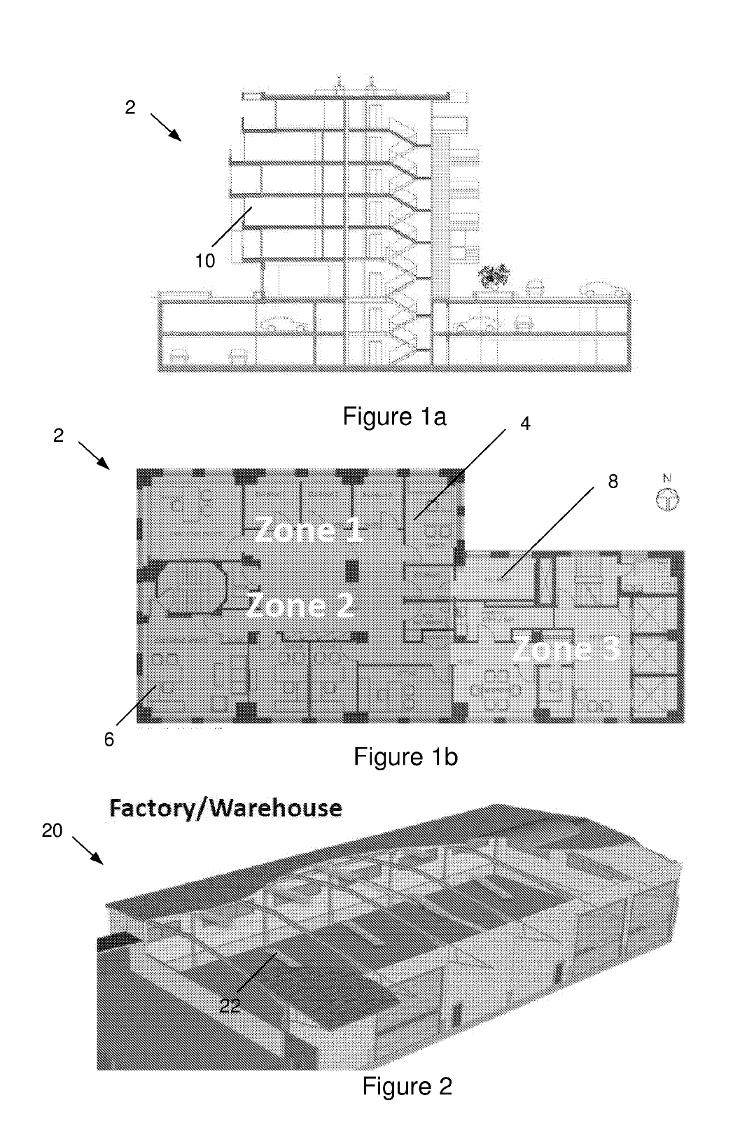

According to an embodiment of the present invention, there is provided a low-energy office building 2 as shown in FIG. 1. The multi-storey building 2 includes a distributed power supply which supplies mains voltage to lights spread throughout the building 2. The distributed power supply includes a mains power supply (e.g. 115V or 240V), a battery storage system, and solar cells mounted on the roof of the building 2 to charge the battery. The building 2 further includes a lighting system 100 for being powered by the distributed power supply and as described in detail below.

Turning to FIG. 1b, the lighting system 100 includes many distributed lights that are arranged in zones 4, 6, 8 within the building 2. Each zone 4, 6, 8 relates to a portion of a given floor 10 (FIG. 1a) of the building 2. The building 2 includes an actuator 202, described in detail below, and for actuating the lights 102 in the zones 4, 6, 8 at intervals.

As shown in FIG. 2, another embodiment of the present invention relates to a factory or warehouse building 20 which also includes vast arrays of distributed lights 22.

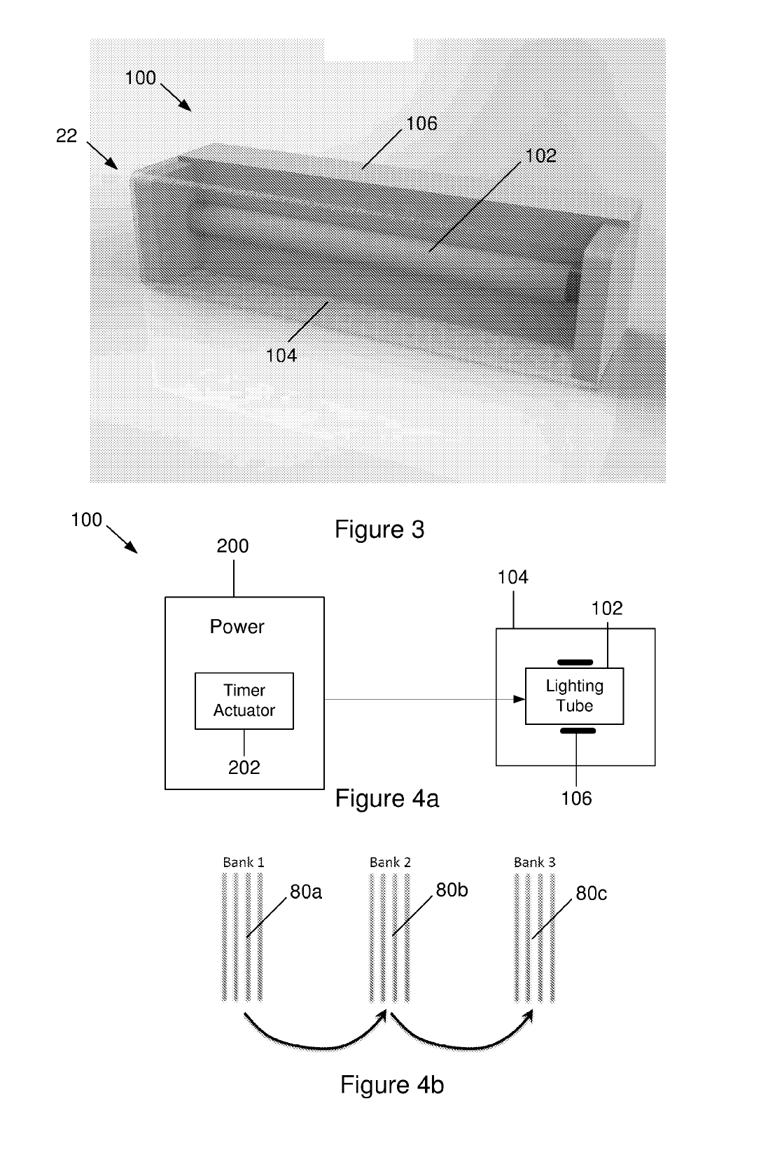

A single light 22 of the building lighting system 100 is shown in FIG. 3. The lighting system 100 includes an internal fluorescent tube 102 (i.e. powered light) and a U-shaped diffuser 104 (i.e. cover) for covering the tube 102. The diffuser 104 snap fits to a tube holder 106 for holding the tube 102. Photoluminescence is contained within the diffuser 104.

Advantageously, the tube 102 charges the photoluminescence in the diffuser 104 when actuated in normal use. When the tube 102 is deactivated, the diffuser 104 passively discharges and provides passive illumination in the dark by virtue of the photoluminescence. The building lighting system 100 provides sufficient passive illumination for after-hours personnel in the building 2 to perform duties after the light is turned off, or in the event of a power disruption when a backup power generator is not present.

Turning to FIG. 4a, the system 100 further includes a programmable power supply 200 for powering each tube 102 in the building 2. The power supply 200 includes a variable timer actuator 202 for actuating each light tube 102 at intervals. The intervals are typically regular intervals (e.g. hourly). The duty cycle of the power supply 200 to each tube 102 is typically less than 10%, which equates to tube actuation for less than 6 minutes in the hour and still provides sufficient charging of the photoluminescence in the diffuser 104 to passively illuminate the building for the remainder of the hour. Accordingly, there is little power consumption per tube 102 over the entire hour. The intervals and duty cycle of the timer actuator 202 can be varied to, in turn, vary the power consumption and passive illumination.

The actuator 202 is configured in a low energy mode to cycle actuation of the lights 102 whereby some of the lights 102 are actuated at one time and other lights 102 are not concurrently actuated, but the lights 102 are all eventually actuated.

In one embodiment, during actuation of the regional zones 4, 6, 8, some of the zones (e.g. 4) are actuated at one time (i.e. with all the lights on) and other zones (e.g. 6, 8) are not concurrently actuated (i.e. with all the lights off), but the zones 4, 6, 8 are all eventually actuated through cycling.

As shown in FIG. 4b, the lights can be arranged in separate banks 80a, 80b, 80c, whereby some of the banks (e.g. 80a) are actuated at one time and other banks (e.g. 80b, 80c) are not concurrently actuated, but during cycling the banks 80a, 80b, 80c are all eventually actuated. The banks 80 can be actuated concurrently in this manner in different zones 4, 6, 8 so that, during concurrent actuation of each zone 4, 6, 8, some of the lights are actuated at one time and other lights are not concurrently actuated, but the lights are all eventually actuated through cycling. For each zone 4, 6, 8, the banks are momentarily actuated in the order 80a, 80b, 80c, before repeating.

Each zone 4, 6, 8 may relate to a part of a floor 10, a respective floor 10, a respective room or a corridor.

In one embodiment, actuation of actuator 202 may also occur upon detection of motion in the zone 4, 6, 8 in question, via the switching of a motion detection sensor or sensors which may be variously installed within the zone 4, 6, 8. Such motion sensing actuation can be used even during periods of normal use, where the lights may be deactivated until motion is sensed, providing passive illumination by virtue of photoluminescence, and thence powered illumination upon motion detection in the zone 4, 6, 8.

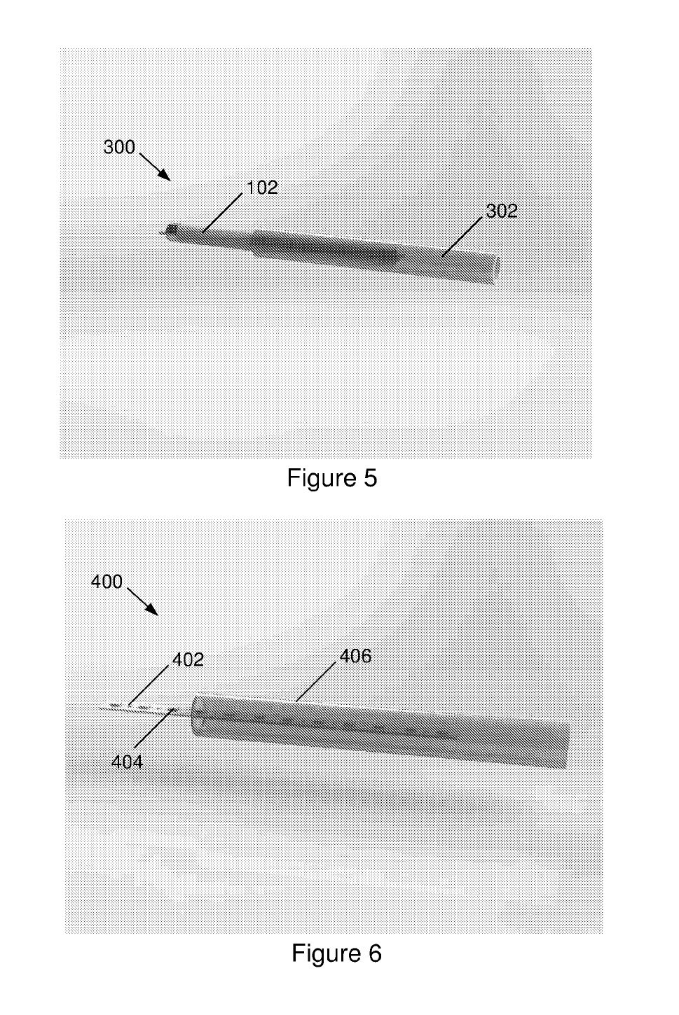

Turning to FIG. 5, an alternative lighting system 300 includes an internal fluorescent tube 102 (i.e. light), and a tubular cover 302 dimensioned to receive and cover the tube 102. The cover 302 contains photoluminescence which provides passive illumination as previous described. The lighting system 300 also includes the power supply 200.

Turning to FIG. 6, an alternative lighting system 400 includes an internal strip 402 of light emitting diodes (LEDs) 404 (i.e. collectively a light). A tubular cover 406 is provided for covering and containing the strip 402. The cover 406 contains photoluminescence which provides passive illumination as previous described. The lighting system 300 also includes the power supply 200.

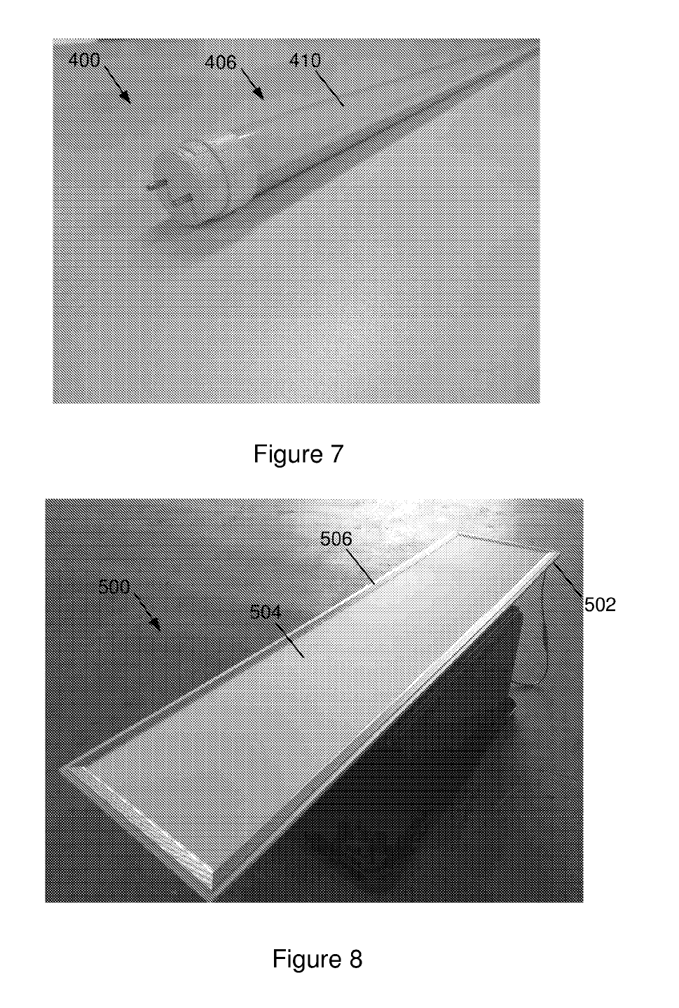

Turning to FIG. 7, the system 400 can be shaped like a fluorescent tube 102 so that the system 400 can be readily substituted for a fluorescent tube 102 in the holder 106. The cover 406 includes two halves, with the lower half 408 being formed from reflective material (e.g. Aluminium) and the upper half 410 being formed from translucent polymeric material including the photoluminescence.

The covers 104, 302, 406, 410 can be extruded, cast or molded. Photoluminescence is not in coating form, and instead is evenly dispersed throughout the covers 104, 302, 406, 410, and the covers 104, 302, 406, 410 include photoluminescence of between 0.25% and 35%, which can be varied to alter the illumination intensity and the cost of the product, in turn, dependent upon the comparatively high cost of the photoluminescence. The photoluminescence may take the form of material disclosed in U.S. Pat. No. 8,801,967.

The powdered photoluminescence is provided in the master batch to be added to the carrier, and has a particle size of less than 80 micron, less than 60 micron, less than 40 micron or less than 20 micron. The smaller particle size facilitates dispersion of the photoluminescence throughout the polymer which results in a brighter and longer lasting passive light. Smaller particle sizes are suitable for transparent and translucent polymers. Larger particles are advantageous in more opaque polymers whereby the particles gravitate toward the surface enhancing passive illumination.

The covers 104, 302, 406, 410 are formed from a plastic compound which is normally initially pelletized. The plastic compound may include polyethylene (PE), polypropylene (PP), polyamide (PA), polyethylene terephthalate (PET), polyvinyl chloride (PVC), polymethyl methacrylate (PMMA), and/or other like hard polymeric material. The photoluminescence is granular material and is mixed through the plastic compound prior to injection molding or extruding the resulting mix.

A method for manufacturing a cover 104, 302, 406, 410 is now briefly described.

First, the photoluminescence is added and mixed throughout the polymer so as to be evenly dispersed in the resultant mixture.

Next, the mixture is heated to between 200 to 250° C. for injection molding with PP, and between 190 to 220° C. for extrusion.

Next, the cover 104, 302, 406, 410 is formed. The covers 104, 302, 406, 410 are formed by extruding or injection molding the heated mixture.

Next, the cover 104, 302, 406, 410, including polymer and photoluminescence, is cooled in a controlled manner so that the cover 104, 302, 406, 410 hardens.

Careful control must be taken with the temperatures during the thermoplastic formation process using the photoluminescent admixture heated mixture. Excess temperatures during cover formation, or overly rapid cooling rates (in ambient surrounds) can lead to poor cover development resulting in material and performance deficiencies. Rapid cooling is however generally desirable for providing a clean injection molded finish so a balance is required. Extruded cooling would tend to be more a gradual process.

The building would typically include hundreds of lighting systems detailed above. As explained above, the passive illumination in place of continuous active illumination of the lights greatly reduces the power consumption and running cost of the system. During daytime, the lights are fully activated for regular personnel. At night, the lights are either deactivated altogether, in which case passive illumination is provided for several hours, or intermittently turned on to recharge the photoluminescence. The amount of photoluminescence can be varied to, in turn, vary the intensity and duration of passive illumination for the particular application.

FIG. 8 shows a building lighting system 500 in accordance with another embodiment of the present invention. The thin system 500 includes a flat LED base 502 with one or more LEDs provided in the form of a planar panel. Furthermore, the system 500 includes a planar panel cover 504, in turn, including photoluminescence. The cover 504 lies adjacent the LED base 502. A rectangular frame 506 borders the LED base 502 (i.e. light), and functions as a connector for connecting the cover 504 and LED base 502 together. Advantageously, the system 500 is flat and planar making it suitable for mounting to a ceiling or a wall of a building.

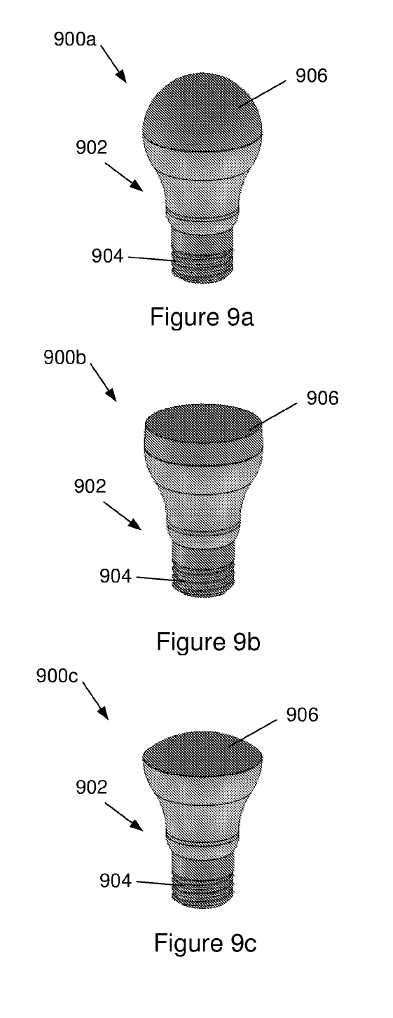

FIG. 9a-c shows three domestic light fittings 900a, 900b, 900c for coupling to a distributed power supply in a residential building lighting system. Each light fitting 900 includes a light 902, in turn, including a threaded base 904 containing an internal light source (not shown). Each light fitting 900 further includes a cover 906, containing the photoluminescence, for covering the light 902. The cover 906 is in the form of a cap for capping the base 904. The cover 906 can be dome shaped (FIG. 9a), flat (FIG. 9b) or slightly arced (FIG. 9c). In one embodiment, the base 904 may include a bayonet fitting.

Turning to FIG. 10, an alternative lighting system 1000 includes an internal dual light 1002. The light 1002 has a strip of white light LEDs 1004 for emitting higher intensity white light and also has a strip of ultra-violet LEDs 1006 for emitting lower intensity ultra-violet light (e.g. blue or purple in color). A tubular cover 406 is provided for covering and containing the light 1002. The cover 406 contains photoluminescence which provides passive illumination as previous described. The lighting system 1000 also includes the power supply 200.

In normal use, the white light LEDs 1004 are actuated to illuminate a building zone. However, in practice, cycling on and off the high intensity white light LEDs 1004 to charge the tubular cover 406 presents a visual nuisance to after-hours staff and is distracting. Accordingly, the white light LEDs 1004 are permanently turned off after hours, and the ultra-violet (UV) LEDs 1006 are instead cycled on and off to charge the tubular cover 406. In this manner, the lower intensity UV cycling is less perceptible to after-hours staff and the tubular cover 406 is rapidly charged.

The ultra-violet LEDs 1006 consume less power when charging the cover 406 than the white light LEDs 1004 otherwise would. The ultra-violet LEDs 1006 also charge the cover 406 quicker. Accordingly, in some applications, only the ultra-violet LEDs 1006 are provided.

Furthermore, the cover 406 may be replaced by any other type of photo-luminescent emitter. For example, the light 1002 may surround the edge of a photo-luminescent panel.

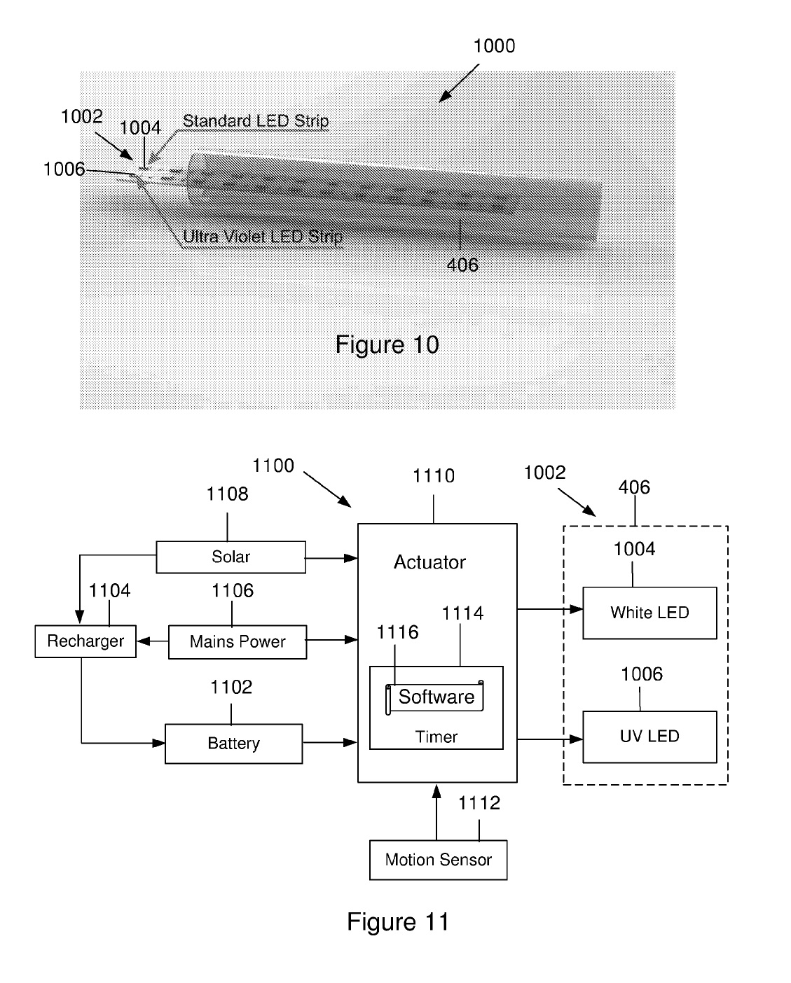

FIG. 11 shows a unitary light replacement 1100 including the lighting system 1000. The light replacement 1100 is a replacement for retrofitting in place of a conventional fluorescent tube. As previously described, the lighting system 100 includes a light 1002 including at least one white light emitting diode (LED) 1004 and at least one ultra-violet (UV) LED 1006. The tubular cover 406 includes photoluminescence and covers the light 1002.

Advantageously, the LEDs 1004, 1006 draw low power. The white LED 1004 is ordinarily continuously operated to charge the photoluminescence. The white LED 1004 is turned off after-hours. The photoluminescence then passively discharges in the dark and provides passive illumination for after-hours personnel. The UV LED 1006 is advantageously activated to recharge the photoluminescence with less annoyance to the after-hours personnel than otherwise actuating the white LED 1004.

The light replacement 1100 includes a long life Lithium Iron Phosphate (LiFePO4) rechargeable battery 1102 for powering the UV LED 1006. The light replacement 1100 includes a recharger 1104 for recharging the battery 1102. The recharger 1104 is powered from a mains power supply 1106 or a solar power supply 1108.

The light replacement 1100 includes an actuator 1110 for actuating the LEDs 1004, 1006. The actuator 1110 includes a voltage regulator, controller and driver circuitry for driving the light 1002. The light replacement 1100 also includes a motion sensor 1112 for sensing motion. The actuator 1110 actuates one or both of the LEDs 1004, 1006 responsive to sensed motion.

The actuator 1110 also includes a timer 1114. The timer 1114 includes software 1116 and is programmable to variably alter the duty cycle (e.g. 5 seconds on, 5 minutes off) of the UV LED 1006 to control the passive brightness of the photoluminescence.

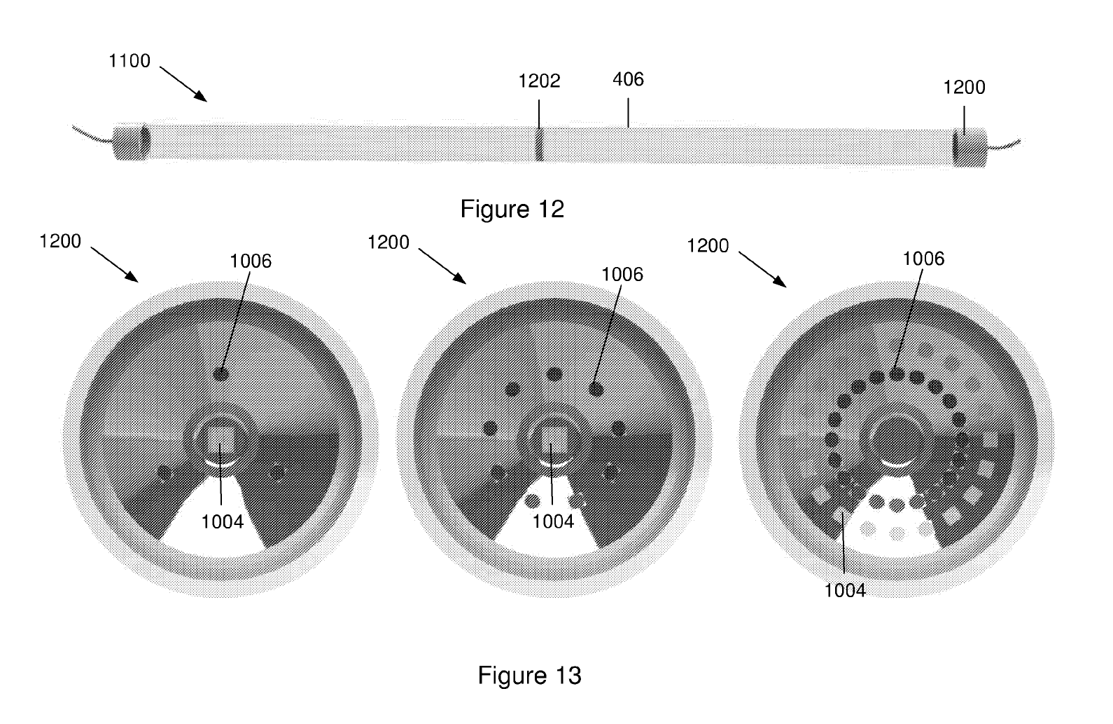

The LEDs 1004, 1006 are typically in strips extending along the tubular cover 406 as shown in FIG. 10. Alternatively or additionally as shown in FIG. 12, the LEDs 1004, 1006 can be mounted at one or both ends of the light replacement 1100 in end caps 1200. The light replacement 1100 includes a central mirror reflector 1202 for reflecting light within the cover 406.

Turning to FIG. 13, various endcap configurations are possible. Each endcap 1200 includes the LEDs 1004, 1006 mounted so that light is transmitted along the cover 406. The LEDs 1004, 1006 can be angled and directional. Diffusers can also be provided for diffusing transmitted light. Each endcap 1200 can include at least one lens for focusing light in the cover 406.

The UV LED 1006 has a wavelength of about 365nm to maximally charge the photoluminescence. The cover 406 preferably includes a thermoplastic, such as polypropylene or Polymethyl methacrylate (PMMA), throughout which the photoluminescence is dispersed and which is formed as previously described. The light replacement 1100 can be powered from a single end in contrast to a standard fluorescent tube.

A person skilled in the art will appreciate that many embodiments and variations can be made without departing from the ambit of the present invention.

In one embodiment, the photoluminescence takes the form of a photoluminescent luminous pigment “master batch”, which contains between 5% and 65% photoluminescent compound. The master batch is incorporated within a polymeric (or plastic) carrier that matches and is added to the base polymeric material to form the body of the cover.

It will be appreciated that all of the embodiments can be periodically turned on and/off as described above using a timer circuit as described with reference to FIG. 4.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A building including:
a distributed power supply; and
a lighting system for being powered by the distributed power supply, the system including:
distributed lights for being coupled to the distributed power supply;
covers for covering respective lights; and
photoluminescence borne by each cover.

2. A building as claimed in claim 1, wherein the photoluminescence is within or dispersed throughout the cover.

3. A building as claimed in claim 1, wherein the distributed power supply includes a mains power supply, a battery and/or solar cells.

4. A building as claimed in claim 1, wherein the building includes an actuator configured to cycle actuation of the lights whereby some of the lights are actuated at one time and other lights are not concurrently actuated, but the lights are all eventually actuated.

5. A building as claimed in claim 1, wherein the lights are arranged in zones within the building.

6. A building as claimed in claim 5, further including an actuator for actuating the lights in the zones at intervals.

7. A building as claimed in claim 5, wherein each zone relates to a respective floor, or a respective room or corridor.

8. A building as claimed in claim 5, wherein further including a motion sensor for sensing motion a zone, and an actuator for actuating lights in the zone responsive to sensed motion.

9. A building as claimed in claim 1, wherein the building is a commercial building, a factory or an office building.

10. A building lighting system including:
a light for coupling to a distributed power supply;
a cover for covering the light; and
photoluminescence borne by the cover.

11. A building lighting system as claimed in claim 10, wherein the system further includes an actuator for actuating the light at intervals.

12. A building lighting system as claimed in claim 11, wherein the actuator includes a variable timer.

13. A building lighting system as claimed in claim 11, wherein the intervals are regular intervals and/or the duty cycle of the power supply is less than 10%.

14. A building lighting system as claimed in claim 10, wherein the light includes a fluorescent tube.

15. A building lighting system as claimed in claim 10, wherein the light includes one or more light emitting diodes (LEDs).

16. A building lighting system as claimed in claim 15, wherein the system is shaped like a fluorescent tube and holds the LEDs.

17. A building lighting system as claimed in claim 15, wherein the LEDs include a strip of LEDs or the LEDs are included in a panel.

18. A building lighting system as claimed in claim 10, wherein the light can emit white light and ultra-violet light.

19. A building lighting system as claimed in claim 10, wherein the cover includes a diffuser, a tube or a panel.

20-35. (canceled)

36. A light arrangement including:
a light including at least one white light emitting diode (LED) and at least one ultra-violet (UV) LED; and
a cover including photoluminescence and for covering the light.

37-48. (canceled)
